(19) United States
(12) Patent Application Publication
(10) Pub. No.: US 2021/0161328 A1
(43) Pub. Date: Jun. 3, 2021

(54) DEVICE FOR TRANSPORTING AND HEATING FOOD AND PROCEDURES FOR OPERATION OF SUCH A DEVICE

(71) Applicant: VORWERK & CO. INTERHOLDING GMBH, WUPPERTAL (DE)

(72) Inventor: CHRISTOPHER PIERNIKOSCH, SPROCKHOVEL (DE)

(73) Assignee: VORWERK & CO. INTERHOLDING GMBH, WUPPERTAL (DE)

(21) Appl. No.: 17/109,745

(22) Filed: Dec. 2, 2020

(30) Foreign Application Priority Data
Dec. 3, 2019 (DE) 10 2019 132 871.3

(51) Int. Cl. A47J 36/24; A45C 11/20; B65D 81/38; A23L 5/00; H05B 1/02; G01G 19/52

(52) U.S. Cl. CPC A47J 36/2483; A45C 11/20; B65D 81/3813; H05B 2203/005; H05B 1/0252; G01G 19/52; A23V 2002/00; A23L 5/00

(57) ABSTRACT

The present invention relates to a device (1) for the transport and heating of foodstuffs, comprising a housing (2) including at least one receiving space (3), at least one heating means (5), and at least one control device (6), wherein the heating means (5) is controllable using the control device (6), and wherein using the heating means (5), energy for the heating of foodstuffs is introducible at least into the receiving space (3), as well as a method for operating such a device. A device (1) for for the transport and for the heating of foodstuffs and a method for operation, wherein the energy requirement for the heating of foodstuffs is optimized, are realized by the heating means (5) including at least one first heating zone (5a) and one second heating zone (5b), and that the first heating zone (5a) and the second heating zone (5b) are controllable independently of each other.

### CROSS-REFERENCE TO RELATED APPLICATIONS

This application claims the benefit of priority under 35 U.S.C. § 119 to German Patent Application No. 10 2019 132871.3, filed Dec. 3, 2019, the contents of which are incorporated herein by reference in their entirety.

### FIELD OF THE INVENTION

The invention relates to a device for the transport and heating of foodstuffs, and a method for operating such a device. The device includes at least one housing including at least one receiving space, at least one heating means, and at least one control device. The housing surrounds the receiving space for receiving foodstuff. The operation of the heating means is controllable using the control device, so that energy for the heating of foodstuffs is introducible by the heating means at least into the receiving space.

### BACKGROUND

Devices for the transport and heating of foodstuffs are known in a variety of designs in the prior art and are also referred to as “lunch box.” Devices for the transport and heating of foodstuffs usually include an electrical heating means that is suppliable with voltage via a power supply, and using which the foodstuffs disposed in a receiving space are heatable. Furthermore, it is known that such devices are programmable, for example, via a smartphone or an input display directly on the device, or at least the heating power is adjustable.

Furthermore, it is known that such devices include, for example, a battery in order to supply the electrical heating means with voltage.

However, the devices known from the prior art have a high energy requirement for the heating of foodstuffs, which in particular is disadvantageous with a power supply having a battery.

The object of the present invention is therefore to specify a device for the transport and for the heating of foodstuffs and a method for operation wherein the energy requirement for the heating of foodstuffs is optimized.

### Summary and Introductory Description of Exemplary Embodiments

The present object is achieved with a device of the above-mentioned type for the transport and for the heating of foodstuffs as described herein such that the heating means includes at least one first heating zone and one second heating zone, and that the first heating zone and the second heating zone are controllable independently of each other. The heating zones can in particular be switched on or switched off independently of each other. The heating zones are preferably operable with different heating powers. For example, the control device includes power electronics for an operation of the heating zones, using which power electronics the heating power of the heating zones is switched, and using which power electronics the heating power of the heating zones is adjustable. In order to realize regulating processes, the device includes, for example, at least one temperature sensor, in particular a plurality of temperature sensors. The temperature sensor is associated with the control device.

In particular, it is provided that the heating means includes more than two heating zones, preferably at least three, at least four, at least five, or at least six heating zones. All heating zones are controllable independently of one another, in particular using the control device.

It is provided that at least two or more heating zones are disposed in a receiving space. In this way different regions of the receiving space can be heated independently of one another and, for example, with different heating powers so that a different amount of energy is introducible into one part of the foodstuff arrangeable in the receiving space than in at least one further part of the foodstuff. In particular, the heating zones are disposed in a plane.

It is also provided that the device includes a plurality of receiving spaces. In order to form a plurality of receiving spaces, the housing includes, for example, fixed separating webs that separate the receiving spaces from one another.

Alternatively or additionally thereto it is provided that at least one separating web is comprised that is variably positionable in a receiving space, which separating web divides a receiving space into two receiving spaces. For example, at least two, at least three, at least four, at least five, or at least six receiving spaces are provided in the housing, or are formable by the arranging of separating webs.

It falls within the context of the invention that each receiving space includes exactly one heating zone of the heating means, or that a receiving space, a plurality of receiving spaces, or all receiving spaces include at least two or more heating zones.

The housing is configured, for example, multi-part, in particular including at least one housing lower part and at least one housing upper part. The housing upper part is configured, for example, as a cover and is preferably pivotably held on the housing lower part. However, it is also provided that the housing upper part is completely removable from the housing lower part. The heating means and the control device are disposed in the housing, in particular in the housing lower part. In the closed state the housing is preferably configured fluid-tight, in particular pressure-resistant. It is thereby prevented that, for example, steam arising in the receiving space escapes from the housing.

Compared to the prior art, the invention has the advantage that the heating of foodstuffs is effected in an energy-saving manner by the different heating zones, since it is possible that only the heating zones that are required for the heating of the foodstuff or foodstuffs are operated. In particular in devices having a battery, do or alter good the service life can thereby be increased. Furthermore, the heating power of each heating zone is individually adjustable so that each foodstuff in each heating zone receives an individual energy input, whereby the preparation quality is also increased.

According to a first design of the device it has been found to be particularly advantageous if it is provided that the heating zones are thermally insulated from one another. For this purpose, the device includes means for thermal insulation of the heating zones from one another. The means for thermal insulation are preferably disposed such that no or only a very slight heat transfer occurs from one heating zone into another heating zone by heat conduction. Means for thermal insulation are also preferably disposed such that no or only very slight heat transfer occurs from one receiving space into another receiving space. Due to the thermal decoupling of the heating zones the foodstuffs in the individual heating zones can be heated completely separately from one another.

According to a further design of the device, in order to be able to regulate the required heating power more precisely, it is preferably provided that at least one weighing device is provided. The weighing device serves for determining the presence of a foodstuff in the receiving space and/or in order to determine the weight of a foodstuff disposed in the receiving space. The control device preferably regulates the heating power of the heating means, in particular of the heating zones, by using the weight of the foodstuff in the receiving space or of the foodstuffs in the receiving spaces. In this way it is ensured that always only the heating power actually required is introduced for heating the foodstuff.

Furthermore, it is advantageously provided that the weighing device includes at least two weighing zones, preferably a number of weighing zones corresponding to the number of heating zones or the number of receiving spaces. Each heating zone in particular includes its own weighing zone. Preferably the respective weight of the foodstuff in each weighing zone and/or the total weight of all foodstuffs in all weighing zones is determinable using the weighing device.

It is preferred if the heating power of at least one heating zone is controllable or controlled depending on at least one measured value of the weighing device. For example, the presence of a foodstuff is determinable and providable as a measured value using the weighing device, in particular of each weighing zone. In particular, the weight of at least one foodstuff in one weighing zone is determinable using the weighing device and is providable as a measured value for controlling the heating means.

In this way the weight of the foodstuff disposed in the respective heating zone can determined separately for each heating zone, and the heating power required for the respective heating zone can be determined and set. These steps are performed by the control device, in particular by at least one processor of the control device. A single weighing zone, preferably at least two weighing zones, are preferably provided in a receiving space.

According to a further design of the device the cleaning of the device can be simplified in particular by providing at least one receiving container, and that the receiving container is disposed in the receiving space for the receiving of foodstuff. The foodstuff can preferably be removed from the receiving space together with the receiving container or introduced therein. The foodstuff is consequently only in contact with the receiving container so that it can be removed from the device and cleaned.

For example, the receiving container includes means for thermal insulation in order to thermally decouple the heating zones and/or a plurality of receiving spaces. It is preferably provided that the device includes a plurality of receiving containers. All receiving containers are insertable into the receiving space or the receiving spaces. For example, the number of receiving containers corresponds to the number of heating zones, in particular in a single receiving space. Each heating zone is consequently associated with at least one receiving container, so that each foodstuff in each receiving container is heatable separately from one another by a heating zone. Furthermore, it is provided that at least two heating zones are associated with each receiving container.

In particular, at least one weighing zone of the weighing device is associated with each receiving container, so that the weight of the foodstuffs in each receiving container is separately determinable, and in particular the heating performance of the respective heating zone is adjustable depending thereon.

According to a further design of the device the mobile use of the device can be improved by at least one energy storage device for the supplying of energy of the heating means being disposed in the housing. The energy storage device supplies the heating means with energy so that the device can be operated self-sufficiently. Preferably the energy storage device is configured as at least one battery for storing electrical energy.

A further design of the device provides that the device includes at least one charging interface for charging the energy storage device. The charging interface is configured in particular as an electrical interface, preferably as an induction interface, as a cable interface, or as an interface to a kitchen appliance. The operating voltage of the heating means is, for example, approximately 12 V, 24 V, 36 V, or 230 V.

The interface to a kitchen appliance is configured, for example, as an induction interface or as a plurality of contact means. A cable interface is configured, for example, as a plug socket, in particular as a USB plug, e.g., micro-USB or USB-C.

It is preferably provided that the control device, in particular a charging electronics of the control device, is configured such that with voltage applied at the charging interface, in particular at the induction interface or at a cable interface, operation of the device is possible. The energy storage is preferably charged and an operation of the device, i.e., a heating of foodstuffs, is simultaneously possible. In this way the device can also be operated and charged with an external energy storage device, in particular a battery or a rechargeable battery.

According to a further design it has been shown in particular as advantageous for the heating of foodstuffs if it is provided that at least one start time and/or one end time, in particular a time of day, and/or a duration of the operation of the heating means, in particular of the individual heating zones, is controllable using the control device. The setting of the control device or a programming of the control device is effected, for example, via keys, provided for this purpose, on the housing or via at least one display having touch function. The user can advantageously manually specify the time at which the foodstuffs should finish heating. In particular based on the information present, e.g., the weight of the foodstuffs, the number of heating zones used, etc., the control device determines a required heating power and heating duration and subsequently independently controls the heating.

In order to increase in particular the operating comfort for a user, according to a further design of the device it is provided that the control device includes at least one data-processing system and at least one data interface. The data interface is preferably configured as a radio interface, for example, WLAN, Bluetooth, or mobile radio. The data-processing system comprises, for example, at least one processor and at least one storage device.

The data interface is configured for the receiving and sending of data. Via the data interface, data, for example, such as battery state, target temperature, actual temperature, weight of the individual weighing zones, as well as times for controlling can be transmitted to further devices, for example, a smartphone or a kitchen appliance, or received by these devices.

The control device is preferably configured such that it is influenceable, for example, configurable, at least via the data interface. A configuring, i.e., adjusting or adapting of parameters such as times and temperatures, occurs in particular by the data interface producing a connection to at least one kitchen appliance or at least one data-processing device. For example, the control device can be controlled via a graphical operating interface of a kitchen appliance or of a smartphone, a heating time can be set, or information about the device, for example, the battery state, a target temperature, an actual temperature, or the weight in the individual heating zones can be retrieved. The user can view and possibly change this data on a graphical interface of the data-processing device, for example, of the smartphone or the kitchen appliance.

In addition, the data-processing system is configured, for example, such that based on the weight of the foodstuffs in the individual weighing zones a required heating power is determined and the control device then optimally supplies the individual heating zones with energy.

In order to advantageously heat foodstuffs in the receiving space, according to a further design of the device it is provided that the control device is formed and configured for processing at least one heating profile, in particular that the heating profile includes at least instructions for controlling the heating zones. A heating profile comprises, for example, control commands that cause the control device to operate the heating means, in particular the individual heating zones, with a certain heating power.

A heating profile comprises, for example, instructions for the duration of the driving of one or more heating zones with a certain power or for varying the power over a period of time and/or the switching-on and switching-off of individual heating zones at predetermined times. A heating profile is producible and/or modifiable and in particular storable in a storage, for example, via an input means of the device, for example, keys and/or a touch display.

A further design of the device provides that at least one heating profile is receivable with the data interface, in particular that the heating profile is executable with the control device. It is preferably provided that the heating profile is transmitted to the device from a smartphone or a kitchen appliance. For example, the foodstuffs are prepared or pre-cooked using a kitchen appliance, and the kitchen appliance transmits to the device a heating profile, corresponding to the cooking recipe, for heating or subsequent cooking of the foodstuffs.

In particular, according to a further design an interaction of the device with the user can be improved such that at least one audio output device is comprised, in particular that the audio output device is configured for outputting information signals or speech. The audio output device is preferably driven by the control device, in particular the data-processing system of the control device. For example, the ending of the heating process can be indicated to a user by a signal tone or a speech output. For example, warning tones or other indication tones as well as speech output are provided for user guidance. Furthermore, it is provided that the device includes at least one microphone so that voice control by a user is possible. For example, the desired instant of time for heating can be set via the voice control.

In order to provide information to the user about the status of the device, according to a further design of the device it is provided that at least one display device, in particular at least one display, is comprised. Using the display, at least one temperature in the receiving state, a charge level of the energy storage device, and/or at least one weight of a foodstuff in at least one heating zone is preferably displayable.

According to a last example design of the device it is advantageously provided that the device includes at least one detecting means. The detecting means is configured, for example, as a camera or as a bar code scanner. Using the detecting means, for example, a bar code, e.g., in a recipe book, can be captured, whereby, for example, a heating profile is requested via the data interface or a heating profile is loaded from the memory of the device. In this way the device can be configured in a user-friendly manner for the optimal heating of a certain foodstuff.

The object is further achieved by a method for operating a device for the transport and heating of foodstuffs, in particular according to one of the above-described exemplary embodiments. The method comprises at least the following method steps:

receiving of at least one heating profile via at least one data interface of the device, wherein the heating profile comprises at least instructions for operating the heating means,

operating of the heating means based on the heating profile.

According to one design of the method, it is provided that the received heating profile has been transmitted by at least one kitchen appliance, or a smartphone, connected via the data interface.

Furthermore, it is provided that the heating profile is produced depending on a foodstuff prepared by a kitchen appliance, in particular the heating profile is produced by the kitchen appliance. The heating profile is consequently selected by the kitchen appliance depending on the foodstuff prepared using the kitchen appliance, and provided for transmitting via the data interface. The kitchen appliance preferably individually generates a heating profile for the prepared foodstuff; the heating profile is configured using parameters of the preparation of the foodstuff in the kitchen appliance. For example, it is provided that the kitchen appliance cooks the foodstuff only to 90%, and based on this information generates a heating profile that takes into account that the foodstuff must not only be heated, but also must be cooked by 10%.

### BRIEF DESCRIPTION OF THE DRAWINGS

Further advantageous designs of the invention arise from the following Figure description and the dependent subclaims.

FIG. 1 shows an exemplary embodiment of a device in perspective view, and

FIG. 2 shows the exemplary embodiment of a device according to FIG. 1 in sectional view.

### DETAILED DESCRIPTION

In the various Figures of the drawings identical parts are always provided with the same reference numbers.

With respect to the following description, the invention is not limited to the exemplary embodiment and here not to all or a plurality of features of described feature combinations, but rather each individual partial feature of the/each exemplary embodiment is also of significance to the subject matter of the invention separately from all others in the context of partial features thus described and also in combination with any features of another exemplary embodiment.

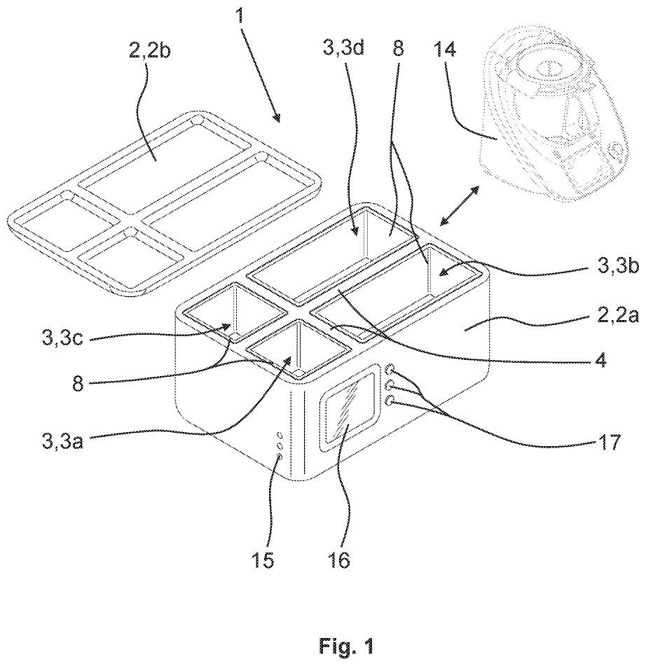

FIG. 1 shows an exemplary embodiment of a device 1 for transport and heating of foodstuffs in a perspective view. The device 1 includes a housing 2 that includes a housing lower part 2a and a housing upper part 2b in the form of a cover. The housing upper part 2b is attachable to the housing lower part 2a. The housing 2 is formed at least partially from a thermally insulating material. In this exemplary embodiment the housing 2 surrounds four receiving spaces 3, namely a first receiving space 3a, a second receiving space 3b, a third receiving space 3c, and a fourth receiving space 3d. The receiving spaces 3 are separated from each other and thermally insulated by fixed separating webs 4.

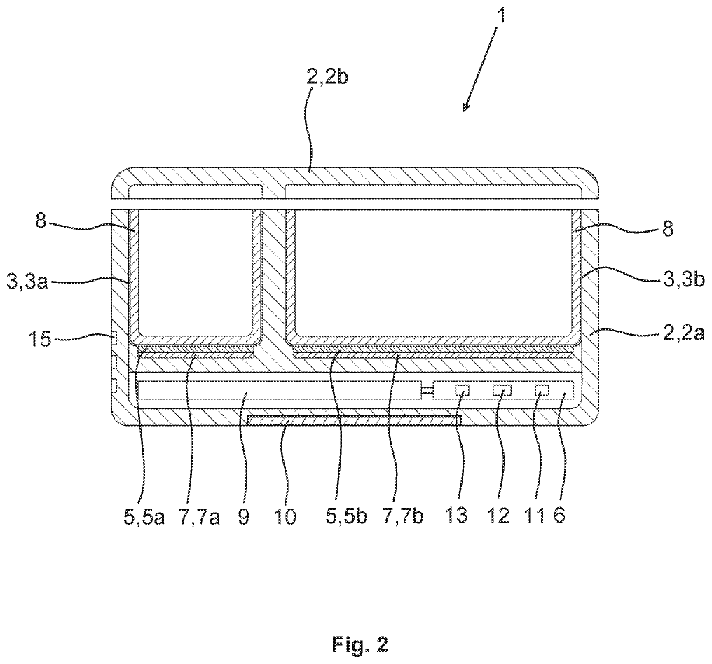

FIG. 2 shows the exemplary embodiment according to FIG. 1 in a sectional view. The device 1 includes a heating means 5 and a control device 6. The control device 6 is disposed below the receiving spaces 3a, 3b, 3c, 3d in the housing 2, in particular in the housing lower part 2a. The heating means 5 is controllable using the control device 6, wherein using the heating means 5, energy for heating the—not depicted—foodstuffs is introducible into the receiving spaces 3a, 3b, 3c, 3d—see also FIG. 1. The control device 6 further includes a—not-depicted—temperature sensor for each receiving space 3a, 3b, 3c, 3d.

The heating means 5 includes a total of four heating zones 5a, 5b, of which two are depicted in FIG. 2 and which are controllable independently of one another. Each receiving space 3a, 3b, 3c, 3d includes a heating zone 5a, 5b. Using the control device 6, for example, each of the heating zones 5a, 5b can be—independently of one another—switched on, switched off, and operated with different heating powers. The heating zones 5a, 5b are thermally insulated from one another.

In addition to the heating means 5, the device 1 includes a weighing device 7, using which the weight of foodstuffs arrangeable in the receiving spaces 3a, 3b, 3c, 3d is determinable. In this exemplary embodiment the weighing device 7 includes a total of four weighing zones 7a, 7b, of which two, namely a first weighing zone 7a and a second weighing zone 7b, are depicted in FIG. 2. The weighing zones 7a, 7b are usable independently of one another. A weighing zone 7a, 7b is provided for each receiving space 3a, 3b, 3c, 3d so that the weight of the foodstuffs is determinable separately for each receiving space 3a, 3b, 3c, 3d. Depending on the weight of the foodstuffs in a receiving space 3a, 3b, 3c, 3d, a heating power, for example, of the respective heating zone 5a, 5b is adjustable by the control device 6.

According to FIG. 1 and FIG. 2, in this exemplary embodiment the device 1 includes four receiving containers 8, wherein a receiving container 8 is respectively inserted into each receiving space 3a, 3b, 3c, 3d. The receiving containers 8 are removable from the receiving spaces 3a, 3b, 3c, 3d so that they are simple to clean. The receiving containers 8 are manufactured, for example, from stainless steel. In this exemplary embodiment the number of receiving containers 8 corresponds to the number of heating zones 5a, 5b.

An energy storage 9 is disposed in the housing 2 below the receiving spaces 3a, 3b, 3c, 3d, in particular in the housing lower part 2a, an energy storage device 9, which in this exemplary embodiment is configured as a battery for storing electric energy. The energy storage device 9 is chargeable via a charging interface 10, which in this exemplary embodiment is configured as an induction interface. The charging interface 10 is formed and configured such that when the device 1 is disposed on a charging coil—not shown—corresponding to the charging interface 10, not only is the energy storage device 9 charged, but an operation of the device 1, in particular of the heating means 5, is possible.

In this exemplary embodiment the control device 6 comprises a data-processing system 11, a data interface 12, and power electronics 13 for operating the heating means 5, in particular the four heating zones 5a, 5b.

The data-processing system 11 of the control device 6 comprises at least one processor and at least one storage for storing data. Data are receivable and sendable via the data interface 12 of the control device 6. In this exemplary embodiment the data interface 12 is configured as a combined WLAN- and Bluetooth-interface. Heating profiles, for example, from a kitchen appliance 14 according to FIG. 1, are receivable via the data interface 12. The heating profile comprises in particular instructions that cause the control device 6, in particular the data-processing system 11 of the control device 6, to operate, via the power electronics 13, the heating zones 5a, 5b of the heating device 5 with a certain heating power. The heating power of the heating zones 5a, 5b is preferably dependent on the type and/or quantity of the foodstuffs introduced into the receiving vessel 8.

Via the data interface 12—according to FIG. 2—the device 1 is also connectable, for example, to a—not-depicted—smartphone such that a graphical user interface for the device 1 is displayed on the smartphone, and the device 1 is programmable via this, for example, a time is adjustable at which the heating of foodstuffs in the receiving containers 8 is to be completed.

According to FIG. 1 and FIG. 2 the device 1 includes an audio output device 15, which in this exemplary embodiment is configured as a loudspeaker and is driven by the control device 6. Using the audio output device 15 a signal is issuable, for example, when the foodstuffs are sufficiently heated.

In addition, the device 1 according to FIG. 1 includes a display device 16, which in this exemplary embodiment is configured as a touch display. A temperature in the receiving space 3, a charge level of the energy storage device 9, and/or the weight of the foodstuffs disposed in the receiving spaces 3a, 3b, 3c, 3d and/or a total weight of all foodstuffs can, for example, be displayed via the display device 16. Furthermore, the device 1 includes three input keys 17 for controlling and for selecting information displayed on the display device 16.

The invention is not limited to the exemplary embodiments shown and described, but rather also comprises all embodiments which work the same way in the sense of the invention. It is emphasized that the exemplary embodiments are not limited to all features in combination, rather each individual partial feature can also have inventive significance in isolation from all other partial features. Furthermore, the invention is so far not yet limited to the combinations of features defined in claim 1, but rather can also be defined by any other combination of specific features of all of the individual features disclosed. This means that in principle practically any individual feature of claim 1 can be removed or replaced by another individual feature disclosed elsewhere in the application.

While the above description constitutes the preferred embodiment of the present invention, it will be appreciated that the invention is susceptible to modification, variation and change without departing from the proper scope and fair meaning of the accompanying claims.

1. A device for the transport and heating of foodstuffs, comprising a housing including at least one receiving space, at least one heating means, and at least one control device, wherein the heating means is controllable using the control device, and wherein using the heating means, energy for the heating of the foodstuffs is introducible at least into the receiving space, wherein the heating means includes at least one first heating zone and one second heating zone, and that the first heating zone and the second heating zone are controllable independently of each other.

2. The device according to claim 1, wherein the heating zones are thermally insulated from each other.

3. The device according to claim 1, further comprising at least one weighing device is provided for determining at least one of the presence or the weight of the foodstuffs arrangeable in the receiving space.

4. The device according to claim 3, wherein the heating power of at least one heating zone is controllable in a manner depending on at least one measured value of the weighing device.

5. The device according to claim 1, wherein at least one receiving container is provided, and that the receiving container is disposed in the receiving space for receiving the foodstuffs.

6. The device according to claim 1, wherein at least one energy storage device for energy-supplying of the heating means is disposed in the housing.

7. The device according to claim 6, wherein at least one charging interface for charging the energy storage device is provided.

8. The device according to claim 1, wherein using the control device a start time or an end time or a duration of an operation of the heating means is controllable.

9. The device according to claim 1, wherein the control device includes at least one data-processing system and at least one data interface.

10. The device according to claim 1, wherein the control device is influenceable at least via the data interface.

11. The device according to claim 1, wherein the control device is formed and configured for processing at least one heating profile, and that the heating profile includes at least instructions for controlling the heating zones by the control device.

12. The device according to claim 9 wherein at least one heating profile is receivable by the data interface of the control device.

13. The device according to claim 1, wherein at least one of at least one audio output device at least one display device or at least one detecting device is provided.

14. A method for the operation of a device for the transport and heating of foodstuffs, comprising the steps of providing a housing including at least one receiving space, at least one heating means, and at least one control device, wherein the heating means is controllable using the control device, and wherein using the heating means, energy for the heating of the foodstuffs is introducible at least into the receiving space,
receiving of at least one heating profile at at least one data interface of the device, wherein the heating profile comprises at least instructions for operating the heating means,
operating of the heating means based on the heating profile.

15. The method according to claim 14, wherein the received heating profile has been transmitted by at least one kitchen appliance or a smartphone connected via the data interface.

16. The method according to claim 14, wherein the heating profile is produced depending on at least one foodstuff arrangeable in the receiving space and the heating profile is produced by a cooking device in a manner depending on a foodstuff prepared by the cooking device.

17. The device according to claim 3, wherein the weighing device includes a number of weighing zones corresponding to the number of heating zones or the number of receiving spaces.

18. The device according to claim 5, wherein the device includes a plurality of receiving containers, wherein the number of receiving containers corresponds to the number of heating zones.

19. The device according to claim 7, wherein the charging interface is configured as an induction interface or as a cable interface or as an interface to a kitchen appliance.

20. The device according to claim 19, wherein via the data interface a connection can be produced to at least one of at least one cooking device or at least one data-processing device.
